(19) United States
(12) Patent Application Publication
(10) Pub. No.: US 2004/0003295 A1
(43) Pub. Date: Jan. 1, 2004

(54) Biometric document authentication system

(76) Inventors: David Elderfield, Calgary (CA); Doug Martyn, Vancouver (CA)

Correspondence Address: JAMES F HARVEY III, HARVEY & ASSOCIATES, 3750 WEST MAIN STREET, SUITE 120, NORMAN, OK, 73072, US

(21) Appl. No.: 10/601,165

(22) Filed: Jun. 20, 2003

Related U.S. Application Data
(60) Provisional application No. 60/389,941, filed on Jun. 20, 2002.

(51) Int. Cl. H04L 9/32

(52) U.S. Cl. 713/202; 382/115

(57) ABSTRACT

A system and method for the verification of trusted documents is shown, wherein a biometric image affixed to an article being shipped is verified as to the identity of the individual vouching for the contents of the article or the membership of the individual is confirmed as being a member of a bonded client group. The system comprises an endorsement system scanning a biometric portion of the individual and providing a biometric image for the document; a verification system for scanning the biometric image from the document presented to the verification system, requesting the biometric image from the database system, comparing the biometric image with the template received as a result of the request and providing an indicator as to whether the document is valid or invalid; and a database system for storage of the biometric images and providing a template describing the image.

### CROSS-REFERENCES TO RELATED APPLICATIONS

This patent application claims priority based upon the following provisional patent application: No. 60/389,941, filed on Jun. 20, 2002, entitled “Passport Verification System”.

### BACKGROUND OF THE INVENTION

The present invention relates to the field of data authentication and verification, and, in particular, to systems relying on biometric data to produce identification devices to authenticate the documents upon which they are irremovably attached and to verify the identity of the agent bearing the documentation. This invention may have direct application in the area of Homeland Security being presently implemented in the United States.

In today's stream of commerce, various documents, collectively defined herein as “identification documentation”, are typically used to establish either the identity of individuals or the origin, ownership, and composition of goods being transported internationally, depending upon the particular circumstances. Biometric data is increasingly being used to establish positive, affirmative identification of these persons, agents, and goods, where “biometric information” is defined as information that is derived directly from one or more physical or behavioral features of a person or other biological entity; such information includes, but is not limited to, fingerprint pattern matching, facial recognition, hand geometry, iris scanning, voice recognition, signatures, x-rays, retinal scans, magnetic resonance imaging, and similar descriptive and/or diagnostic information. Additional information may be derived from single or joint biometric data sources through analytical techniques. For example, a fingerprint may yield geometry information descriptive of the fingerprint or reflectivity values characteristic of the particular fingerprint.

One example of a system for detecting and differentiating tissue is given in U.S. Pat. No. 6,560,352, by Rowe et al., which describes an apparatus and method for identification of individuals by using optical spectroscopy with preferred wide band, infrared black body source emitting optical wavelengths of between 1000 and 2500 nanometers (nm). Alternatively, the energy source is described as a light source that emits light in the silicon region of the spectrum, defined as the spectral range over a silicon detector is active and is roughly between 350 and 1000 nm. Rowe teaches that this range is optimal for detecting and differentiating sub-epidermal tissue samples and does not consider other materials besides human skin or the geometry of the image in the identification process.

Some types of documentation in particular may be termed identification documentation and may include such standard documents as passports, citizenship cards, and driver's licenses, for example. Other documentation for which endorsement and verification is appropriate are such things as financial documents (securities instruments, stock certificates, etc.), contracts, and international transportation documents (bills of lading and waybills, for example). Biometric data collection for use in the endorsement and verification of this documentation in a real-time environment has required significant infrastructure investments by corporate customers, government bodies seeking to rely upon these documents, or both. A significant portion of these investments are made because of new systems being incompatible with prior standards, new systems having to translate between standards, and systems incapable of being implemented in phases over time. In most instances verification and authentication of existing identification, documentation requires real-time data collection at approved sites.

Given the state of precision counterfeiting capabilities that are readily available using new technologies, there exists a need for a secondary and verifiable endorsement procedure to validate authenticity and responsibility for the action being carried out. Concerns regarding audit trail chronology and verifying the date of sensitive and valuable securities documents, and tracing of ownership in the international movement of cargo accent the need for a secondary and verifiable endorsement procedures.

Verification of identification documentation is a two part process. First, the document itself must be proven authentic or official in its issue. Second, the presenter of that identification documentation must be confirmed as its proper owner or an authorized agent of the proper owner.

Currently, existing on-line systems that collect full biometric information at approved third party sites and transmit that information via electronic network for database storage and verification constitute “brute force” solutions that have the capability to identify and track individuals. Under the outline of the Biometric Bill of Rights (California State Government, 1994) this may constitute an infringement of personal privacy. On-line biometric data collection technology systems can only be implemented effectively in financially strong “First-World” nations. Less economically advantaged countries generally do not have the resources to implement such inherently costly systems. Therefore, such systems are not likely to become global solutions or to be effective in verifying incoming travelers from other less economically capable nations.

As can be seen, there is a need for an inexpensive methodology for authentication of sensitive and valuable documentation, such as, for example, passports, credit cards, driver's licenses, or citizenship identity cards, or the origin and ownership of goods being transported internationally, such as, for example, bills of lading, waybills, or packing slips. The methodology should additionally respect the privacy of individuals.

### SUMMARY OF THE INVENTION

In one aspect of the invention, a system for authenticating a document is provided, where the system comprises an endorsement system, a verification system, and a database system. The endorsement system may have a first scanning component, a printing component, and a first processing component. The first scanning component may obtain biometric information from a first person presenting the document, the first processing component may receive the biometric information and provide a biometric image, and the printing component may apply the biometric image to an article. The database system may provide storage for the biometric image, it may respond to a request for the biometric image by providing a template comprising extracted features of the biometric image. The verification system may have a second scanning component and a second processing component. The second scanning component may obtain the biometric image from the document presented to the verification system by a second person. The second processing component may request the biometric image from the database system, compare the biometric image with the template received as a result of the request, and provide an indicator as to whether the document is valid or invalid.

In another aspect of the invention, an endorsement system is provided and comprises a means for capturing biometric data from a finger or thumb of a person; a means for augmenting the biometric data with a signature of the person; a means for further augmenting the biometric data with a date/time stamp; a means for providing a biometric image from the augmented biometric data; and a means for affixing the biometric image to an original document provided by the person. The original document with the affixed biometric image may subsequently be positively verified as authentic so that it may be confidently used for evidentiary purposes.

In yet another aspect of the invention, a method is provided for authenticating a document presented by a person, the document having an access code visibly imprinted thereon, where the method comprises the steps of successively illuminating a biological portion of the person with light spectra from a light emitting source, each light spectrum having a wavelength successively and exhaustively chosen from a set of selected spectral ranges; developing a digital geometrical representation of the biological portion; encoding the digital geometrical representation as a biometric image; storing the biometric image in a database in association with the access code; imprinting a label with the biometric image using a dye sublimation printing process; applying the label to the document; and verifying the authenticity of the document by comparing the biometric image imprinted on the label on the document with a template derived from the biometric image stored in the database and associated with the access code, the biometric image having been retrieved from the database as a result of manual entry of the access code.

In still another aspect of the invention, a method is provided for endorsing a photo identification document presented by a person, where the method comprises taking a photograph of the person; successively illuminating a biological portion of the person with light spectra from a light emitting source, each light spectrum having a wavelength successively and exhaustively chosen from a set of selected spectral ranges; developing a digital geometrical representation of the biological portion; encoding the digital geometrical representation as a biometric image; imprinting the back of the photograph of the person with the biometric image using a dye sublimation printing process; submitting an application by the person for a photo identification document, the application including the photograph; storing a digital image of the photograph and the biometric image in a database; obtaining an address associated with the digital image and the biometric image; providing a second photograph having the address imprinted on the reverse side of the photograph in barcode form to the person; and verifying the authenticity of the photo identification document by comparing the biometric image obtained from the person and a template derived from the biometric image stored in the database, the biometric image associated with the address.

These and other features, aspects and advantages of the present invention will become better understood with reference to the following drawings, description, and claims.

### BRIEF DESCRIPTION OF THE DRAWINGS

FIG. 1 shows a block diagram of a document authentication system, according to embodiments of the invention;

FIG. 2 shows a block diagram of a endorsement system, according to embodiments of the invention;

FIG. 3 shows a block diagram of a validation system, according to embodiments of the invention;

FIG. 4 shows a flow chart giving the steps that may be performed by an embodiment of the invention when used as a stand-alone document endorsement device;

FIG. 5 shows a flow chart giving the steps that may be performed by the Database System, according to embodiments of the invention; and

FIG. 6 shows a flow chart giving the steps that may be performed by the validation system, according to embodiments of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

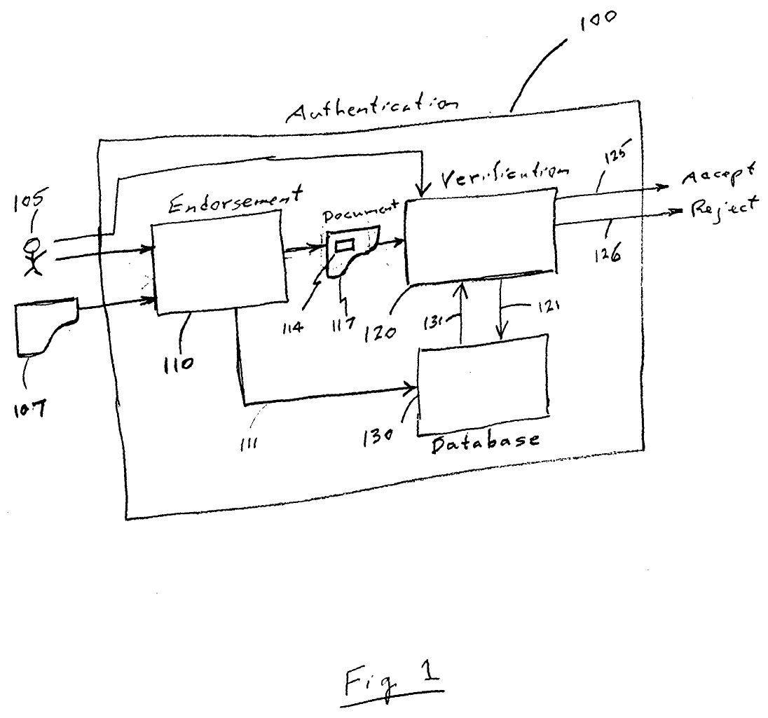

The invention provide systems, methods, devices, and software for authentication of documents using biometric indicia to associate the document with a trusted source. A block diagram of an embodiment of the system is shown in FIG. 1, in which a biometric document authentication system 100 may comprise three subsystems according to the invention—an endorsement system 110, a verification system 120, and a database system 130. The methods by which these systems may interact ensure that documents may have a self-validating, biometric image associated therewith that cannot be altered and that allows the document to be easily, rapidly, and confidently verified for authenticity.

The biometric document authentication system 100 shown in FIG. 1 may accept as input a document 107 to be endorsed and biometric data provided by a person 105. The Endorsement System 110 may receive this input and provide a biometric image 114 that may be incorporated into the document 117 in such a way that it cannot be separated from the document 117 without destroying it. The document 117 may be later provided to a Verification System 120 to examine the biometric image 114 to determine whether or not the document 117 is authentic. Some documents 117 may serve to identify the person 105, in which case the person 105 may be required to again provide the biometric data to the Verification System 120 so that it may be checked against the biometric image 114 contained in the document 117. The Verification System 120 may provide an accept/reject indicator 125, 126 that indicates whether or not the document 117 is authentic. A Database System 130 may assist the Verification System 120 by providing templates of previously stored biometric images, as indicated by the arrow 131. The biometric images may be provided to the Database System 130 either by the Endorsement System 110, as indicated by the arrow 111; by the Verification System, as indicated by the arrow 121; or by a scanning system (not shown) associated with the Database System 130 itself.

The invention also provides a system, method, devices, and software for an Endorsement System for endorsing documentation with a biometric image so that the documentation may be subsequently verified. The invention provides a hardware endorsement device that may be used to receive biometric data, generate a biometric image corresponding to the biometric data, and imprint the biometric image onto an item for later verification.

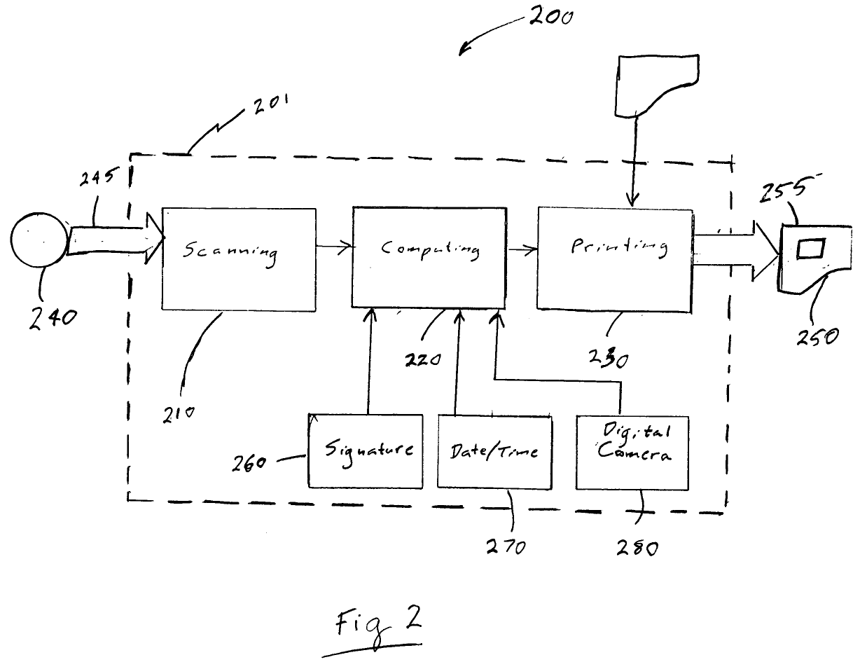

Referring to FIG. 2, an embodiment of an Endorsement System 200 is shown schematically in a block diagram. The Endorsement System 200 may include a scanning component 210 for receiving identification information 245 derived from an item 240 presented thereto; a computing component 220 that receives the identification information 245, processes it, and generates image data; and a printing component 230 for imprinting an image 255 derived from the image data onto a document 250. The document 250 to which the image 255 is imprinted may be a record accessible personal identity (RAPID) document, such as, for example, citizen passports, pass cards, identification cards, or driver's licenses. The document 250 may also be a label for affixing to an identification document. The image 255 may be imprinted to various other kinds of documentation without departing from the scope of the invention. The item 240 presented to the scanning component 210 may be, for example, a biological member such as a finger or thumb or a document having an encoded imaged previously imprinted upon its surface. Other kinds of items 240 from which identification data 245 may be derived may be presented without departing from the scope of the invention.

Optionally, other components may be included to provide additional information for imprinting with the image 255. For example, a signature component 260 may be provided for receiving a signature of the individual person presenting the item 240 to the scanning component 210. A date/time component 270 may also be included to add the current date and time at which the image 255 was provided to the document 250. For passport applications, a digital camera component 280 may be provided for taking a digital picture of the individual so that it may be incorporated into the image 255. Additional input devices may be incorporated without departing from the scope of the invention.

The scanning component 210 may be any suitable device for obtaining information 245. For example, a generic image capture circuit may be typically employed as the scanning component 210. Such circuits may be comprised of a printed circuit board (PCB) having incorporated therein a digital signal processor (DSP) video controller, complementary metal-oxide-silicon (CMOS) imaging circuits, capacitance for flash lighting of prismatic optics, three high output light emitting diodes (LED) of different spectral range, a dedicated flash memory, and a switching power supply/filtering circuit. An optical and lighting arrangement may be used to generate twelve images, provided by two CMOS imaging circuits for six lighting spectra, in order to determine the geometry and hyperspectral content of the item 240 submitted for scanning. Much of this information may not be needed for geometry capture but can be analyzed for hyperspectral content such as hypercubes associated with reflectance, fluorescence and Raman measurements. This may provide for accurate geometry correction and validation of the underlying item 240. In the case of fingerprint capture, the characteristics of skin would be a preliminary check in identifying the item 240 submitted. In the case of document capture, the expected material response of the particular document could be validated first.

TABLE I
Representative Scanning Values

| | | | CPU | |
|---|---|---|---|---|
| | Wavelength | Tim | Processing | |
| Image # | (nm) | (sec.) | Time (sec) | |
| 1 | 180-240 | 0-0.3 | 0.3-0.7 | Data I |
| 2 | 270-330 | 0.3-0.6 | 0.7-1.1 | Data I |
| 3 | 360-420 | 0.6-0.9 | 1.1-1.5 | Data II |
| 4 | 450-510 | 0.9-1.2 | 1.5-1.9 | Data II |
| 5 | 540-600 | 1.2-1.5 | 1.9-2.3 | Data II |
| 6 | 630-690 | 1.5-1.8 | 2.3-2.7 | Data II |
| | | | | Data III - - - derived from |
| | | | | the filtered and |
| | | | | template corrected |
| | | | | images 1-6 |

Table I gives a representative spectral range and timing values for an embodiment of a typical scanning component 210. As can be seen from Table I, six (6) images may be provided by the scanning component 210, with each image being formed by combining the separate results provided by each of the two CMOS imaging circuits. It has been found that a dual arrangement provided by two such imaging circuits may be adequate for an image from which the necessary analysis may be made. The images may be obtained by sequentially tuning the circuits to successive members in a set of selected spectral ranges. The values given in Table I have been found to provide an acceptable set of images for determining the material category of the object scanned and for determining a geometric representation of the object. In particular, the given set of spectral ranges provides adequate information for determining whether or not the material being scanned is a biological entity, such as human skin, or a type of document. In this embodiment, the images resulting from the first two spectral ranges, designated as Data I, may be used to provide sufficient information to determine the material category of the object, in this case, skin or not skin, and the remaining four images, designated as Data II, may be used for more accurate description of the object. By filtering a combination of both data I and Data II images and by comparing them with a template reflecting the characteristics of the sought-after object, a geometric description of the object may be derived.

The printing component 230 may imprint the image 255 onto the document 250 by using standard printing techniques known to the art. For security reasons, a printing technique employing a sublimation dye process may be used, so that the image 255 becomes integral with the document 250 and therefore cannot be altered or separated from the document 250 without destroying the document 250 or being detectable. For example, in the case of a passport, the printing component 230 may print a biometric image derived from scanning the individual's thumbprint onto the rear surface of a standard passport format photograph using the sublimation dye process. Optionally, the sublimation printing process of the printing component 230 may also be provided with the resolution and capability to enable it to print an actual photographic image if a digital camera component 280 is available to provide suitable input.

The computing component 220 may be a standard processing chip well known to the art. It may contain a software program in a memory component for providing the required functionality for the Endorsement System. It may also have sufficient input/output capability to handle multiple components and sufficient speed to provide results within a reasonable time.

When functioning in a stand-alone mode as a document endorsement device, the BDE may be used to obtain biometric data from the individual presenting the document and then to imprint a readable or encrypted biometric image derived from the biometric data of the individual presenting documentation. The biometric data may obtained from the scanning component of the BDE by scanning a biological feature of the individual, such as for example the individual's thumbprint, to obtain spectral data unique to the individual. Additional information, such as for example the individual's signature and a date/time stamp, may be combined with the biometric data to create a unique biometric image representing an encoded combination of the information. The biometric image may then be imprinted directly upon the document being endorsed or upon a label that can be immovably attached to the document.

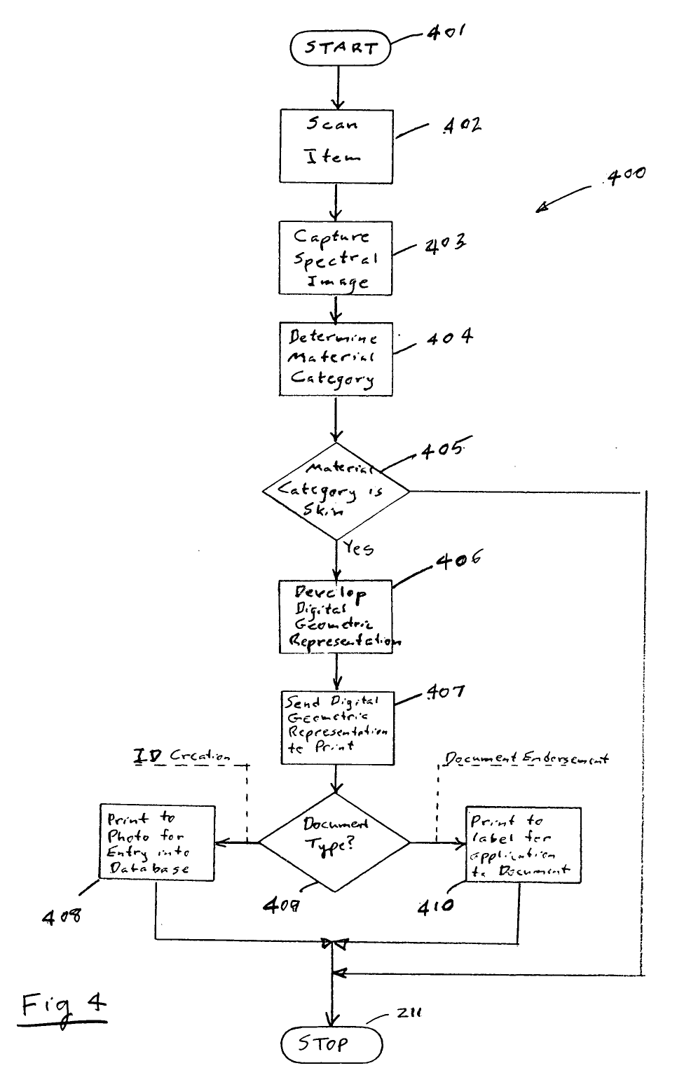

FIG. 4 shows a flow chart 400 of a sequence of functions that may be performed to accomplish these purposes when the Endorsement System is used in an offline mode. The Endorsement System may remain quiescent at the block indicated as 401 until such time that it is activated. Activation may occur by the act of placing a finger or thumb into a scanning area so that it activates a switch, by pressing a switch on the Endorsement System casing to activate the device, or other ways commonly known in the art. When activated, the Endorsement System begins to perform its sequence of functions. In the block indicated by 402, the Endorsement System may scan the finger or thumb by directing a plurality of light sources, each having a different spectral range, towards the finger or thumb. In the block indicated by 403, the spectral image of the finger or thumb is recorded for analysis. In the block indicated by 404, the spectral response of the finger or thumb is sensed and recorded as an image. Using this image, the Endorsement System may then determine the material category in the block indicated by 404. Different materials respond differently in their response to the light sources and human skin has an identifiable pattern. The spectral image is compared with an internal template for human skin response in the block indicated by 405. If the response is not characteristic of human skin, then the Endorsement System will exit, according to the block indicated by 411. If the response is characteristic of human skin, according to the block indicated by 411, then the Endorsement System will develop a digital geometric representation of the finger or thumb according to the block indicated by 406. This geometric representation is then formatted into a biometric image for printing. Additional data such as a signature or a date/time stamp may be added at this time to the biometric image. According to the block indicated by 409, if the document to be endorsed is an identification document, then the printer may impress the biometric image directly onto the identification document. If the document to be endorsed is a paper document, then the Endorsement System may print the biometric image to a label for application to the document. When the image has been output, then the Endorsement System may stop according to the block indicated by 411.

One hardware device embodying an Endorsement System, by way of example, is a Biometric Data Endorser (BDE). The BDE may have particular application where it is desirable to provide a label containing biometric data for application to a document. The BDE may be capable of capturing the biometric information from a person either presenting or vouching for the document and a date/time stamp. This data may be digitally encrypted and encoded as a barcode. This barcode, representing resulting biometric image, may be onto a clear adhesive label. In this case, the sublimation printer may transfer a dye through an adhesive mask and imprint the encrypted biometric image onto a clear plastic surface of the label where it is completely protected. This label may be subsequently bonded to a document such as, for example, bills of lading for containerized cargo, proofs of ownership, or shipping manifests. Ideally, the label may have pre-printed calibration marks thereon to assist the scanning component in locating the bar code on the label. The calibration marks may include one or more circles visible in the ultraviolet spectral range.

In the case of bills of lading, the owners of the cargo or their representatives might use a BDE supplied by the cargo carrier at the time of pickup to identify the document. This process would have two advantages over existing methods. First, there may be a verifiable data image attached to the cargo that can be saved for future reference/comparison if that container is found to have illegal contents (flagging future containers from the same source). Second, the cargo carrier can offer a database service for repeat customers to become members in a “Bonded Client List” making the cargo origin and ownership verifiable from the BDE label data, which means that such cargo may enjoy expedited clearance though customs agencies for recognized freight forwarders and their regular trusted clientele.

In another example, the BDE may be used to imprint the biometric image on the back of a photograph for identification of a person. When the document is a passport, the BDE may be set up in a passport studio for off-line use for imprinting the passport photo with the biometric image on the reverse side of the photo. The BDE may also incorporate into the image the business telephone number of the photo studio, the date the photo was taken, and the two traditional signature lines. When this image is applied to the reverse side of the photo using the dye sublimation process, it may be absorbed into the paper lamina of the photo where it cannot be separated or altered without destroying the photo. When the passport applicant decides to give the photo and the associated data to the government in a passport application, the data may be added to a secured database, or Database System, to provide criteria for later template comparison purposes.

The invention also provides a system, method, and software for a Verification System for verifying the validity of the document or person presented to the system. The Validation System may provide the functions of receiving either biometric data from an individual or a biometric image from a document; generating a biometric image if biometric data is being presented, comparing the biometric image with a template from a database, and providing an indication of whether or not there was a match between the template and the biometric image. The Validation System may be a dedicated system for verifying document authenticity as well as verifying that the person presenting the document to the system provides biometric information that matches that contained on the biometric image of the document.

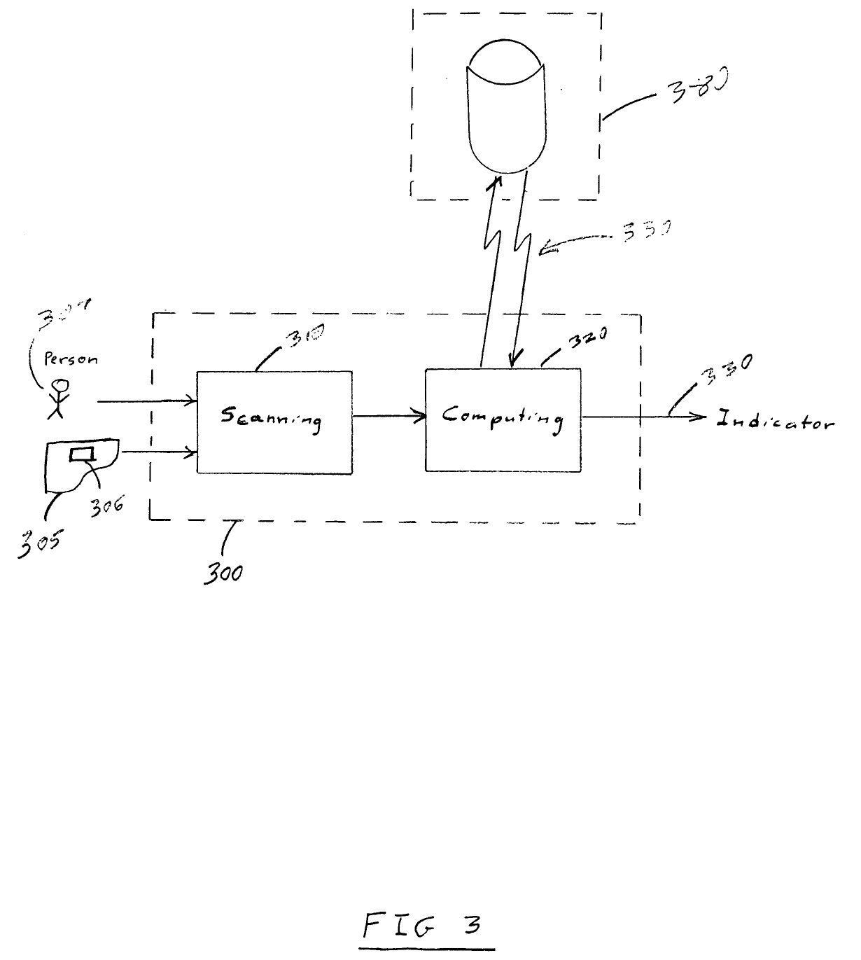

An embodiment 300 of a Verification System is shown in FIG. 3. It comprises a scanning component 310 and a computing component 320. The scanning component 320 may be the same as the scanning component 210 of the Endorsement System 200 (FIG. 2). The Validation System may obtain biometric information from a person 307 or a biometric image 305 on a document 306. The computing component 320 receives the biometric information and the biometric image 306, analyzes them, and determines what data to request from the Database System 380, as will be explained later. A communications link 330 is provided for transmitting addresses and images to the Database System 380 and receiving templates for comparison purposes.

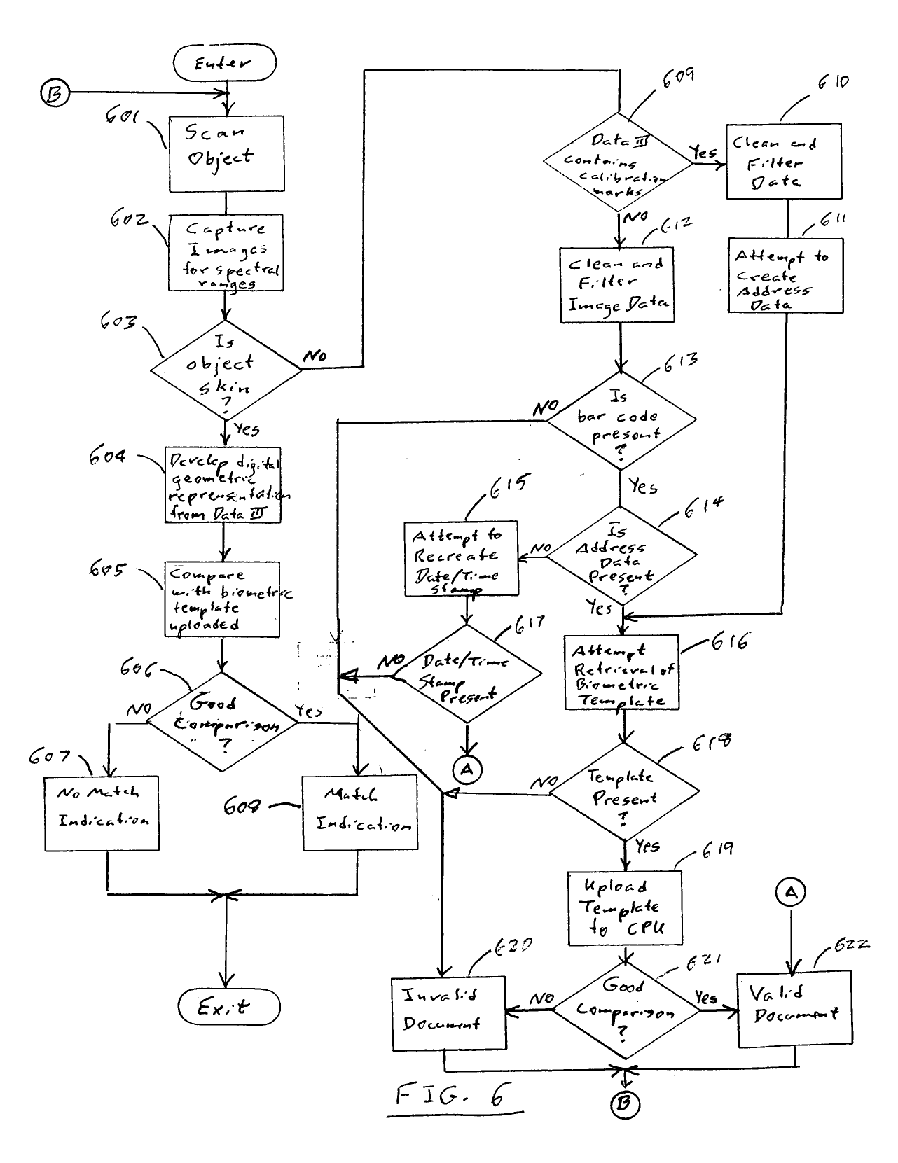

FIG. 6 shows a flow chart 600 of a sequence of functions that may be performed by the Validation System to accomplish these purposes. During standard operation of the Validation System, a documentation object is first presented for validation, and if the operator subsequently feels that a further biometric check of the person's biometric data is warrented, the second object presented for scanning is a biological object, such as a finger or thumb. An object is presented to the scanning component of the Validation System as indicated in block 601. The scanning component as indicated in block 602, steps through the same sequence of spectral ranges as was done in the Endorsement System. The response of the object's matrix or substrate may be captured so that the material may be subsequently determined. Like paper currency, many legally sensitive and valuable documents use specially watermarked and bonded paper that responds to a hyperspectral sequence in a very predictable manner. A determination may be made, according to block 603, whether the material category is skin or not. If the object is not skin, then it must be some kind of document. The calibration marks may be captured by the CMOS chips when lighted in the ultraviolet or near ultraviolet spectra, namely, Image I data. The Data III images may therefore be examined to determine whether or not they are present, according to block 609.

If the calibration marks are present, then a weight analysis may be performed on the sector defined by the calibration marks, according to block 610. It may be divided into batches of 2×2 pixels, and each batch may be measured for spectral response. The batches may then be shifted by one pixel and the process repeated. By subtracting the response of each initial batch from the corresponding response of the shifted batch, a low level differential may be obtained. This is a typical process in image smoothing and can be done by shifting same size batches or by varying the batch sizing in the sequence. The differential may be quantifiable and can be weighted, thus permitting a series of values to be created, where each value is associated to the specific batch differential. This may be repeatable, since orientation and boundary are predetermined by the calibration mark. This repeatable series of values defines the address data of where the temporary verification file will be parked. An attempt is made examine the results of the weight analysis and create an address or access code which identifies a database record containing biometric data of the original purveyor of the document, according to block 611. Control is transferred to block 616. However, if calibration marks are not present in block 609, then the scanned image must contain a bar code. The image data may be cleaned and filtered, according to block 612, in an effort to locate the bar code. If the bar code is not present, according to block 613, then the document is judged to be invalid, according to block 620, and a message to that effect is sent to the operator of the Verification System. Otherwise if a bar code is present, according to block 613, then a determination is made in block 614 as to whether the bar code contains an address or access code which identifies a database record containing biometric data of the original purveyor of the document. If the address data is not present, according to block 614, then an attempt is made in block 615 to recreate the biometric and date/time stamp data from the image. If the image data does not contain the data, according to block 617, then the document is judged to be invalid, according to block 620, and a message to that effect is sent to the operator of the Verification System. Otherwise, the image data does contain a date/time stamp, according to block 617, and the document is considered to be valid, according to block 622.

If an address code was present, according to either block 611 or block 614, a request is sent to the database system to retrieve a template for the address, as indicated in block 616. The template is not the original biometric data, but an abbreviated extract from the biometric data consisting of six points and six vectors. In this way, actual biometric data is not transmitted so that the authentication system is not subject to compromise by interception of the transmission. If the database system does not find an image, according to block 618, document is judged to be invalid, according to block 620, and a message to that effect is sent to the operator of the Verification System. If it does find a biometric image, then the template representing that image is transmitted to the Verification System and the operator is prompted to perform a biometric check of the individual presenting the document. The flow of control restarts with block 601, but this time the person will present a biometric object for scanning and image will be captured according to block 602.

The If the object is skin, according to block 603, such as a person's finger or thumb, then the Data III images may be analyzed and a digital geometric representation may be developed, according to block 604. The geometric representation may be compared with the template that was previously transmitted from the Database System, according to block 605. A determination is then made as to whether or not the scanned biometric image matches the template according to block 606. If there is a match, then a match or success indication is made according to block 607; if not, then a no-match or unsuccessful indication is made according to block 608.

One hardware device embodying a Verification System, by way of example, is an Industrial Data Assistant (IDA). The IDA may comprise a scanning component having the same physical configuration as that of the BDE and a computing component. It may be configured for harsh environmental conditions and would be suitable for use in airports and border crossings where the conditions can be highly humid, where temperatures may be extreme, and where harsh cleaners and disinfectants may be used to reduce the transfer of contagions. The IDA may have a color LCD and a communications port for interacting with remotely located sites over a global communications system such as the Internet. Since the IDA may be installed in a public area, it may be configured with a special mounting bracket with an induction circuit and an matched IC (i.e. IDA and bracket may be a matched set). If the IDA is removed from the bracket and reattached, then the IDA goes from condition 0 (indicating normal operation) to condition 1 (flagged) so that tampering can be rapidly detected. If the bracket is removed from its fastened position and the whole unit is moved and remounted, then the IDA then goes to condition 2 requiring a full reset by authorized personnel.

The invention also provides a system, method, devices, and software for a Database System hosting a database storing biometric images for verification purposes. The Database System may include a scanning component for input of the biometric images; a storage component providing standard database functions such as storage, query, and retrieval; and a processing component for screening the biometric images to ensure that they themselves are valid.

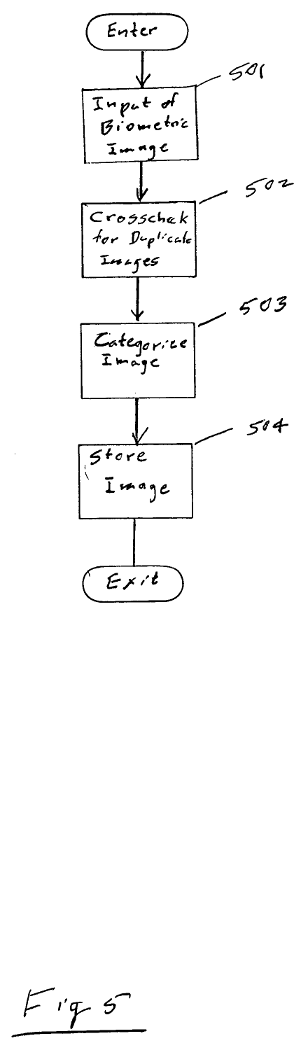

Referring to FIG. 5, the biometric image may be input into the Database System, according to block 501. The biometric image may be transmitted electronically over a communication link to the Database System or it may be directly input to the Database System through a scanning component. For example, a person having a photograph that has been imprinted according to the invention and desiring to apply for a passport may present the photograph to governmental authorities, who would then enter the biometric image on the reverse side of the photograph into the Database System by scanning the information. When the biometric image has been entered into the Database System, then a series of screening tests may be run to ensure that the biometric data is valid. According to block 502, the biometric image may be crosschecked against all other such biometric images in the database to ensure that it is unique. In the case of a passport photograph, this would ensure that multiple passport applications are not being made under assumed names. Other checks could be run at this time to ensure internal consistency of the biometric image. According to block 503, the biometric image may also be categorized at this time according to either extrinsic data entered by operational personnel or intrinsic data contained in the biometric image. For example, the biometric image may be added to a list of trusted, bonded agents who have been previously verified, according to papers received with the biometric image. In addition, any date/time stamp information might be extracted and saved as ancillary textual data with the image. Finally, the biometric image may be stored for later retrieval as needed, according to block 504.

The Database system provides pre-determined templates that are compared against the original biometric image by the Verification System. The templates can be very limited in their scope and data content. In the case of a biometric image, the transmitted data for verification can be set so low that the template is only useful for a match/no match decision against the original and will have no value for extrapolation or interpolation in an attempt to recover the original biometric image. In this way the system is useful only in verification of claimed identity and cannot be used for identification without an individual's knowledge.

The systems and apparatus described heretofore may be used separately or jointly in a continuum of methods, each successive method providing increasing levels of authentication. Each of these methods will now be described.

Level 1. Basic Documentation Endorsement

The basic method of endorsing documentation may be for a person vouching for the document to provide biometric data, such as a finger or thumb print and a signature, which may be incorporated into a biometric image on a label for affixing to the document being endorsed. A date/time stamp may also be added to the label. The document may be subsequently authenticated by scanning the biometric image on the label to determine the identity of the person and the date/time the document was labeled. No interaction with a database is necessary. This method might be considered as an automated version of the traditional notarization process. In terms of the invention, this method may be implemented by using a BDE in stand-alone mode to receive the biometric data and provide the requisite label. Examples of documents that may be appropriately endorsed in this manner are securities documentation, financial instruments, and contracts.

A variant of this method might be applied to the area of shipping and transportation, in which documents such as bills of lading and waybills might be endorsed according to the method. In this case, if a problem is found with cargo at the receiving end of the transaction, then the biometric image on the document may be scanned, decrypted, and stored in a database in a list of suspects. The documents associated with subsequent shipments might be scanned and compared to the list of suspects to determine whether or not the shipment should be checked or inspected more carefully.

Level 2. Documentation Endorsement with Bonded Agent List

This method supplies more security than that of Level 1 and comprises the same basic endorsement method of Level 1. The document being endorsed should have additional information on the document to provide an indicia of unique identification for the document, such as, for example, an account number. A list of bonded agents may be assembled on a Database System, where each agent on the list will have that agent's biometric data stored. When the document must be authenticated, the list may be manually accessed according to the indicia of unique identification. The document may be verified by a Verification System by manually providing the indicia to the Database System so that a template representing the agents on the list may be retrieved and provided to the Verification System. The Verification System may then scan the biometric image from the label and compare it with the template provided by the Database System to verify the document. In terms of the invention, this method may be implemented by using a BDE in stand-alone mode to receive the biometric data and provide the requisite label and by using an IDA to receive the templates for document verification. Examples of documents that may be appropriately endorsed in this manner are bills of lading and waybills.

Level 3. Photo Identification Documentation Endorsement

This method applies to identification documents and provides an enhanced level of security over Level 2. As stated previously, verification of identification documentation is a two-part process. First, the document itself must be proven authentic or official in its issue. Second, the presenter of that identification documentation must be confirmed as its proper owner or an authorized agent of the proper owner.

According to this method, an Endorsement System may affix a biometric image to the reverse side of a photograph of the person. The biometric image may contain biometric data of the person, such a finger or thumb print, a signature, and a date/time stamp. The photograph may then be retained by the person until the person desires to apply for an official identification document. When the person applies for an official identification document, the person may will submit the photograph having the biometric image along with the application to the appropriate agency. The agency may then scan the photograph and biometric image and store them onto a Database System to retain the information for future identification purposes. A second photograph may be provided to the person from the Database System in the form of an identification document, but with a barcode providing an access code to the person's biometric image in the Database System instead of the biometric image itself. The access code may be a record number, a key value, an address, or some other appropriate identifier of the person's data within the Database System.

Verification of the identification document may be subsequently accomplished by a Verification System. The Verification System may scan the access code from the identification document and send it to the Database System via a communications link in order to retrieve a template describing the biometric data in storage for the person. The person's biometric data is obtained by the Verification System and compared with the template to determine if there is a match. It should be noted that no actual biometric data is ever transmitted by communications link, and the template that is returned contains insufficient information by which to reconstruct the biometric data. Thus, the privacy of the person is protected from compromise.

In terms of the invention, this method may be implemented by using a BDE in stand-alone mode to receive the biometric data and provide the requisite label and by using an IDA to receive the templates for document verification. Examples of documents that may be appropriately endorsed in this manner are passports and drivers licenses.

Level 4. Non-Resident Photo Identification Documentation Endorsement

This method might apply to situations where a non-resident person having a passport issued by another country wishes to enter a country that has implemented the invention. In such a case, the non-resident's passport would not necessarily have a biometric image. According to this method, when the non-resident person enters the country, a transparent label having calibration marks may be manually applied to an arbitrary location on the person's identification documentation, so that the substrate of the document may be discerned through the label. The document may then be scanned to capture the area of the identification documentation where the label is applied. An access code may then be created by developing a weighted image response for all pixels within the bounds of the calibration marks. The access code may be used to transmit the person's biometric data to the Database System for storage into a temporary area. Subsequent verification of the person's identification documentation may be made by the Verification System, which may scan the person's identification documentation and develop the access code from a weighted image response for all pixels within the bounds of the calibration marks on the label. This access code may be used to request the Database System to transmit a template for the biometric data associated with the access code. This template may be compared against the biometric image on the label and optionally the person's biometric data to determine whether the person's identification documentation may be verified.

By utilizing this labeling process, persons entering the country may endorse their own passports as they enter from poorer nations. Temporary database files can then automatically be opened and store the limited vector file. This file may be closed as the person leaves the country by rescanning the label and the individual's thumbprint. If there is no matching file to close, then the person becomes a candidate for close scrutiny. If the file is not closed in a pre-determined or reasonable period, then it may become red-flagged as being overdue.

In terms of the invention, this method may be implemented by using a BDE to receive the biometric data and provide the requisite label with calibration marks and by using an IDA to receive the templates for document verification. Examples of documents that may be appropriately endorsed in this manner are passports and drivers licenses of foreign visitors to a country.

Inventive systems, methods, and devices have thus been disclosed for authenticating documents by means of applying a biometric image to the document using a dye sublimation process. The authentication system provided by the invention comprises an Endorsement System for obtaining biometric information and imprinting it upon the document by means of a dye sublimination printing process; a Verification System for examining the endorsed document to determine whether it is valid, and a Database System for storing biometric images for later recall and development of comparison templates. It should be understood, of course, that the foregoing relates to preferred embodiments of the invention and that modifications may be made without departing from the spirit and scope of the invention as set forth in the following claims.

We claim:

1. A system for authenticating a document, the system comprising
an endorsement system having a first scanning component, a printing component, and a first processing component, the first scanning component obtaining biometric information from a first person presenting the document, the first processing component receiving the biometric information and providing a biometric image, the printing component applying the biometric image to an article;
a database system providing storage of the biometric image, the database system responding to a request for the biometric image by providing a template comprising extracted features of the biometric image; and
a verification system having a second scanning component and a second processing component, the second scanning component obtaining the biometric image from the document presented to the verification system by a second person, the second processing component requesting the biometric image from the database system, the second processing component comparing the biometric image with the template received as a result of the request and providing an indicator as to whether the document is valid or invalid.

2. The system described in claim 1, wherein the printing component uses a sublimation dye process to apply the biometric image onto the article.

3. The system described in claim 1, wherein the article is a passport photograph.

4. The system described in claim 1, wherein the article is a label.

5. The system described in claim 4, wherein the label contains pre-printed calibration marks and is capable of being applied to the document, wherein removal or alteration of the label is visually detectable.

6. The system described in claim 5, wherein the document is a bill of lading.

7. The system described in claim 1, wherein the biometric information is provided by a fingerprint.

8. The system described in claim 1, wherein the first person and the second person are the same person.

9. The system described in claim 1, wherein the second scanning component obtains biometric information from the second person and the second processing component compares the biometric data with the template.

10. An endorsement system comprising
a means for capturing biometric data from a fingerprint of a person;
a means for augmenting the biometric data with a signature of the person;
a means for further augmenting the biometric data with a date/time stamp;
a means for providing a biometric image from the augmented biometric data; and
a means for affixing the biometric image to an original document provided by the person;
whereby the original document with the affixed biometric image may subsequently be positively verified as authentic so that it may be confidently used for evidentiary purposes.

11. The system described in claim 10, wherein the means for affixing the biometric image to an original document comprises a sublimation dye printing process.

12. The system described in claim 10, wherein the means for capturing biometric data comprises a scanning component with a plurality of imaging circuits and a light source capable of providing a discrete set of wavelengths, each imaging circuit digitally capturing the response of the fingerprint to successive exposures to light having the different wavelengths.

13. A method for authenticating a document presented by a person, the document having an access code visibly imprinted thereon, the method comprising
successively illuminating a biological portion of the person with light spectra from a light emitting source, each light spectrum having a wavelength successively and exhaustively chosen from a set of selected spectral ranges;
developing a digital geometrical representation of the biological portion;
encoding the digital geometrical representation as a biometric image;
storing the biometric image in a database in association with the access code;
imprinting a label with the biometric image using a dye sublimation printing process;
applying the label to the document; and
verifying the authenticity of the document by comparing the biometric image imprinted on the label on the document with a template derived from the biometric image stored in the database and associated with the access code, the biometric image having been retrieved from the database as a result of manual entry of the access code.

14. The method described in claim 13, wherein the biological portion is a member of the group consisting of the fingers and the thumbs of both of the person's hands.

15. The method described in claim 13, wherein the document is chosen from the group consisting of a bill of lading and a waybill.

16. The method described in claim 13, wherein manual entry of the access code comprises the steps of reading the access code from the document by an operator and entering the access code through a computer terminal.

17. A method for endorsing a photo identification document presented by a person, the method comprising
taking a photograph of the person;
successively illuminating a biological portion of the person with light spectra from a light emitting source, each light spectrum having a wavelength successively and exhaustively chosen from a set of selected spectral ranges;
developing a digital geometrical representation of the biological portion;
encoding the digital geometrical representation as a biometric image;
imprinting the back of the photograph of the person with the biometric image using a dye sublimation printing process;
submitting an application by the person for a photo identification document, the application including the photograph;
storing a digital image of the photograph and the biometric image in a database;
obtaining an address associated with the digital image and the biometric image;
providing a second photograph having the address imprinted on the reverse side of the photograph in barcode form to the person; and
verifying the authenticity of the photo identification document by comparing the biometric image obtained from the person and a template derived from the biometric image stored in the database, the biometric image associated with the address.

18. A system for endorsing a document for subsequent verification comprising
an endorsement system having a first scanning component, a printing component, and a first processing component, the first scanning component for obtaining biometric information from a person for attachment to the document, the first processing component for receiving the biometric information and providing a biometric code, the printing component for attaching the biometric code to the document to create an endorsed document.
